(19) United States
(12) Patent Application Publication
(10) Pub. No.: US 2008/0075455 A1
(43) Pub. Date: Mar. 27, 2008

(54) DIMMER FOR LCD SCREEN OF DIGITAL CAMERA

(76) Inventor: Biguang Lin, Shantou (CN)

Correspondence Address: BELL, BOYD & LLOYD, LLP, P.O. Box 1135, CHICAGO, IL, 60690, US

(21) Appl. No.: 11/535,029

(22) Filed: Sep. 25, 2006

(51) Int. Cl. G03B 11/04

(52) U.S. Cl. 396/534

(57) ABSTRACT

A dimmer includes a window panel connected to a viewing screen area of a device with light-shielding plates provided thereon, the light-shielding plates including a plurality of plates respectively hinged at window edges of the window panel. A window of the window panel is closed off when each plate is folded, while a light-shielding structure is formed in front of the screen when each plate is straightened up. Torsion springs or the like automatically straighten up the left and right side plates and are respectively provided at hinged positions of the two plates and the like. A flat-plate magnifying lens, whose pulled-out end projects from the edge opposite to the hinged edge of the upper plate is slidably fitted in a sandwiched cavity. The flat-plate lens is positioned right in front of the screen when it is pulled out and folded downwardly.

### FIELD OF TECHNOLOGY

The invention relates to a component of photographing apparatus, more particularly to a dimmer for liquid crystal display (LCD) screen of digital camera.

### BACKGROUND

Digital cameras are generally provided with a LCD screen for photographers to observe the viewing conditions or to conveniently browse pictures that have been taken. However, existing digital cameras have no dimmer for the LCD screen on themselves, and thus it is difficult for the photographer to see the LCD screen clearly under sunshine or strong light, which imposes great influence on the effect of photography. In view of this, various dimmers for LCD screen of the digital camera have been developed for overcoming said shortcomings of existing digital cameras.

The dimmer for LCD screen of the digital camera described in Chinese Patent Application No. 200520054935.4 is of the same type with similar structure which includes a window panel connected to the LCD screen area of the digital camera and light-shielding plates provided on the window panel, the light-shielding plates consisting of upper, lower, left side and right side plates respectively hinged at the window edges of the window panel. The window of the window panel is closed off when the four plates are folded, while a rectangular sight tube is formed in front of the LCD screen when the four plates are straightened up, wherein torsion springs for automatically straightening up the lower, left side and right side plates are respectively provided at the hinged positions of the three above-mentioned plates, and a fixing part to be fixed to the window panel is arranged at the non-hinged edge of the upper plate. Usually no lower plate is provided in the dimmer of the same type with similar structure, so that when the three of the upper, left side and right side plates are straightened up, a canopy-shaped structure is formed in front of the LCD screen. This type of dimmer has no other functions than shielding light and protecting the LCD screen. For some dimmers, the window of the window panel is covered with a transparent sheet for preventing the LCD screen from scrapes and dust.

At present, due to the limitation of the camera housing, most LCD screens of digital cameras have relatively small effective area, which may result in difficulty in viewing and poor observation effect. However, as yet there is no special component adapted to attach to the digital camera for magnifying the pictures on the LCD screen so as to facilitate viewing them.

### SUMMARY

Under the exemplary embodiments detailed below, an improved dimmer for a viewing screen is disclosed herein. Under the embodiment, a dimmer for a LCD screen comprises a window panel connected to the screen area of a device, such as a digital camera, and light-shielding plates are provided on the window panel. The light-shielding plates include an upper, a left side and a right side plates respectively hinged at window edges of the window panel, with a window of the window panel being closed off when each of the plates is folded, while a light-shielding structure is formed in front of the LCD screen when each of the plates is straightened up. Torsion springs are preferably provided for automatically straightening up the left side and right side plates are respectively provided at the hinged positions of the left side and right side plates, and a fixing part to be fixed to the window panel is provided at a non-hinged edge of the upper plate. A sandwiched cavity is provided inside the upper plate, and a flat-plate lens for magnifying, whose pulled-out end projects from the edge opposite to the hinged edge of the upper plate, is slidably fitted in the sandwiched cavity, where the flat-plate lens is positioned right in front of the LCD screen when it is pulled out and folded downwardly.

The above-mentioned flat-plate lens for magnifying may be a Fresnel lens, a flat-plate graded index lens or the like. The so-called flat-plate type is defined in terms of its overall visual form rather than its microstructure. If the above-mentioned flat-plate lens is replaced by a convex lens, the upper plate will be increased in its thickness and weight. In this case, it is not preferable, but still falls within the scope of the present disclosure.

The above-mentioned light-shielding structure may be like a canopy. When a lower plate hinged at the window edge of the window panel is added as one of the light-shielding plate according to the present invention, the light-shielding structure may be like a rectangular sight tube. A torsion spring for automatically straightening up the lower plate can be preferably provided at the hinged position of the lower plate.

The connecting structure for connecting the above window panel to the camera body may be a clamp or clamping block for snapping into a slot of the camera, or adhesive strips for adhering to the periphery of the LCD screen. Also it is possible to secure the window panel by mounting it in the tripod-connecting hole in a bottom face of the camera.

The fixing part for fixing said upper plate to the window panel may be in the form of a clamping structure, or a magnetic attraction structure.

The presently disclosed configuration provides the following beneficial effects. Since a sandwiched cavity is disposed in the upper plate, a flat-plate lens for magnifying, whose pulled-out end projects from the edge opposite to the hinged edge of the upper plate, is slidably fitted in the cavity, and the flat-plate lens is positioned right in front of the LCD screen when it is pulled out and folded downwardly, the flat-plate lens can be used, if required, to magnify the picture on the LCD screen, enabling to see the picture clearly and contributing considerably to the accurate determination of the photography effect. Furthermore, since the flat-plate lens is arranged in the sandwiched cavity of the upper plate in such a manner that it can be retracted into the sandwiched cavity until it is pulled out for use, it is convenient and will not hamper the light-shielding and protection functions of the LCD screen. Moreover, the invention allows the existing dimmer for LCD screen of the digital camera to have more functions, broadening its applications through improved techniques.

### BRIEF DESCRIPTION OF THE DRAWINGS

The various objects, advantages and novel features of the present disclosure will be more readily apprehended from the following Detailed Description when read in conjunction with the enclosed drawings, in which:

FIG. 1 shows a schematic section view of an exemplary embodiment of a dimmer, illustrated with the plates straightened upward;

FIG. 2 shows a schematic view of the dimmer of FIG. 1 with the plates in folded position;

FIG. 3 shows a schematic perspective view of the dimmer of FIG. 1 with the flat-plate lens pulled out;

FIG. 4 shows a status diagram of the dimmer of FIG. 3 with the flat-plate lens folded downwardly;

FIG. 5 shows a schematic section view of another embodiment of the dimmer according to the present invention (with the plates straightened up);

FIG. 6 shows a schematic status diagram of the dimmer of FIG. 5 with the plates in folded position;

FIG. 7 shows a perspective view of the dimmer of FIG. 5 with the flat-plate lens pulled out; and

FIG. 8 shows a status diagram of the dimmer of FIG. 7 with the flat-plate lens folded downwardly.

### DETAILED DESCRIPTION

### Brief Description of Reference Signs

1. window panel
2. upper plate
3. left side plate
4. right side plate
5. torsion spring
6. non-hinged edge
7. magnetic attraction part
8. sandwiched cavity
9. flat-plate lens
10. pulled-out end of the flat-plate lens
11. window panel
12. upper plate
13. left side plate
14. right side plate
15. lower plate
16. torsion spring
17. flat-plate lens

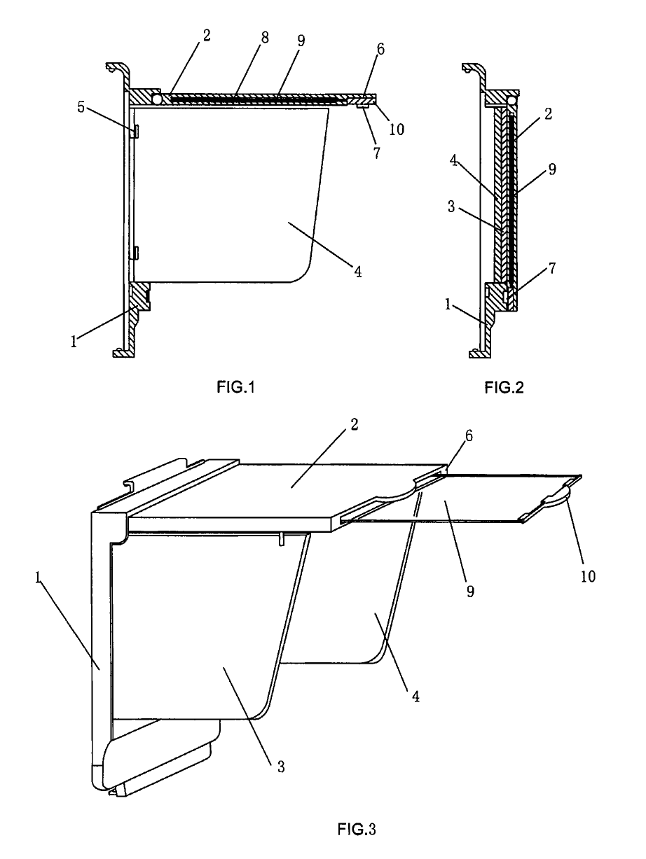

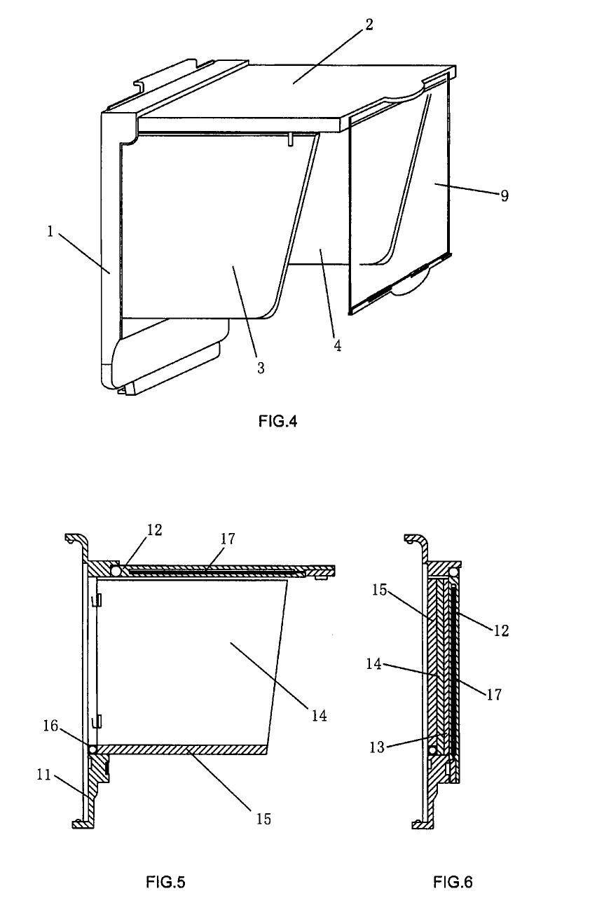

Referring to FIGS. 1-4, a dimmer for LCD screen of a digital camera according to an embodiment includes a window panel 1 connected to LCD screen area of the digital camera and light-shielding plates disposed on the window panel 1, the light-shielding plates consisting of an upper plate 2, a left side plate 3, a right side plate 4 respectively hinged at corresponding window edges of the window panel 1. A window of the window panel is closed off when each of the plates 2,3,4 is folded, as shown in FIG. 2, while a canopy-shaped structure is formed in front of the LCD screen when each of the plates 2,3,4 is straightened up, as shown in FIG. 1, wherein torsion springs 5 or the like for automatically straightening up the left side plate 3 and the right side plate 4 are respectively arranged at the hinged positions of the two above-mentioned plates, and a magnetic attraction part 7 to be attractively fixed to the window panel 1 is provided at the non-hinged edge 6 of the upper plate 2. A sandwiched cavity 8 is provided inside the upper plate 2, and a flat-plate lens 9 for magnifying, whose pulled-out end projects from the edge opposite to the hinged edge of the upper plate 2, is slidably fitted in the cavity 8. The flat-plate lens 9 is positioned right in front of the LCD screen when it is pulled out and folded downwardly, as shown in FIG. 4.

Referring to FIGS. 5-8, a dimmer for LCD screen of a digital camera according to another exemplary embodiment differs from that shown in FIGS. 1-4 in that light-shielding plates of the dimmer consist of an upper plate 12, a left side plate 13, a right side plate 14 and a lower plate 15 respectively hinged at the window edges of the window panel 11. A rectangular sight tube is formed in front of the LCD screen when each of the plates 12,13,14,15 is straightened up. A torsion spring 16 or the like for automatically straightening up the lower plate 15 is provided at the hinged position of the lower plate 15. Other structures are identical with those of the dimmer for LCD screen of the digital camera as shown in FIGS. 1-4.

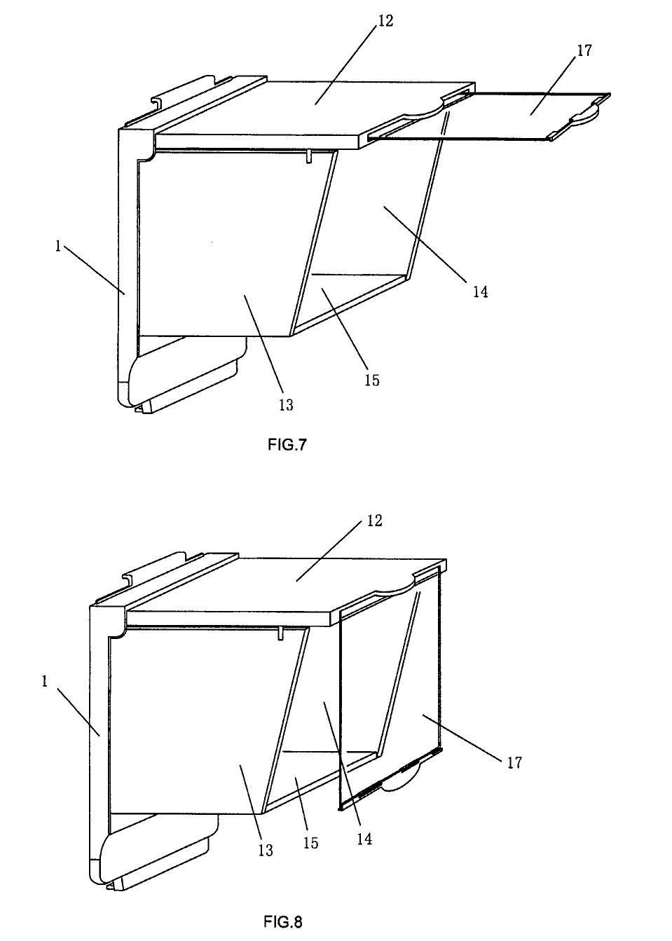

When the above-mentioned dimmers is provided in the state as shown in FIG. 4 or FIG. 8, it is possible to see the magnified picture on the LCD screen of the digital camera clearly from the flat-plate lens 9 or 17.

While the invention has been described with reference to one or more exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the appended claims.

The invention is claimed as follows:

1. A dimmer for a screen, comprising:
a window panel, comprising light-shielding plates, the light-shielding plates including an upper, a left side and a right side plates respectively hinged at window edges of the window panel, wherein a window of the window panel is closed off when each of the plates is folded, and a light-shielding structure is formed in front of the screen when each of the plates is straightened up, and wherein a sandwiched cavity is formed inside the upper plate;
torsion springs that automatically straighten up the left side and right side plates at the hinged positions of the left side and right side plates;
a fixing part fixed to the window panel at a non-hinged edge of the upper plate;
a flat-plate magnifying lens, whose pulled-out end projects from an edge opposite to the hinged edge of the upper plate, and is slidably fitted in the sandwiched cavity, wherein the flat-plate lens is positioned in front of the screen when it is pulled out and folded downwardly.

2. The dimmer as claimed in claim 2, wherein the screen is an LCD screen for an electronic device.

3. A dimmer for a screen, comprising:
a window panel, comprising light-shielding plates, the light-shielding plates including an upper, a left side and a right side plates respectively hinged at window edges of the window panel, wherein a window of the window panel is closed off when each of the plates is folded, and rectangular sight tube is formed in front of the screen when each of the plates is straightened up, and wherein a sandwiched cavity is formed inside the upper plate;
torsion springs that automatically straighten up the left side and right side plates at the hinged positions of the left side and right side plates;
a fixing part fixed to the window panel at a non-hinged edge of the upper plate;
a flat-plate magnifying lens, whose pulled-out end projects from an edge opposite to the hinged edge of the upper plate, and is slidably fitted in the sandwiched cavity, wherein the flat-plate lens is positioned in front of the screen when it is pulled out and folded downwardly.

4. The dimmer as claimed in claim 3, wherein the screen is an LCD screen for an electronic device
